(19) United States
(12) Patent Application Publication
(10) Pub. No.: US 2018/0091641 A1
(43) Pub. Date: Mar. 29, 2018

(54) Repeater for frictionless access control system

(71) Applicant: Sensormatic Electronics, LLC, Boca Raton, FL (US)

(72) Inventor: James Trani, Billerica, MA (US)

(21) Appl. No.: 15/278,814

(22) Filed: Sep. 28, 2016

(51) Int. Cl. H04M 1/725; H04W 4/00; H04W 12/08

(52) U.S. Cl. CPC H04M 1/72533; H04W 12/08; H04W 4/008

(57) ABSTRACT

In an access control system, an ancillary user device is used in conjunction with a mobile computing device to broadcast user information for authentication. The mobile computing device and ancillary user device are paired, and user information is transmitted from the mobile computing device to the ancillary user device. The user information can be stored and/or hashed by the ancillary user device, and an origin flag can be set on the user information, before the user information is transmitted to the positioning unit of the access control system. An attachment mechanism attaches the ancillary user device to the user's body.

### BACKGROUND OF THE INVENTION

Security systems are often installed within and around buildings such as commercial, residential, or governmental buildings. Examples of these buildings include offices, hospitals, warehouses, schools or universities, shopping malls, government offices, and casinos. The security systems typically include components such as system controllers, access control readers, video surveillance cameras, network video recorders (NVRs), and door controllers, to list a few examples.

The access control readers are often installed at access points of the buildings to control access to restricted areas, such as buildings or areas of the buildings. Examples of access points include front and interior doors of a building, elevators, hallways connecting two areas of a building, to list a few examples. The access control readers authenticate identities of (or authorize) individuals and then permit those authenticated individuals to access the restricted areas through the access points. Typically, individuals interact with the access control readers by swiping keycards or bringing contactless smart cards within range (approximately 2-3 inches or 5 centimeters) of a reader. The access control readers read the information of the keycards and then the access control systems determine if the individuals are authorized to access the restricted areas. If the individuals are authorized to enter the restricted areas, then the access control readers allow access to the restricted areas by unlocking locked doors, signaling that doors should be unlocked, activating elevators, or generating alarms upon unauthorized entry, for example.

One proposed system is directed to a frictionless access control and tracking system. A frictionless system uses wireless technology that enables a more transparent method for identifying and tracking individuals while providing similar access control and tracking as traditional systems and methods. The present system can automatically identify and track individuals and enable access to restricted areas when authorized individuals are approaching or in threshold areas of the access points. Threshold areas are typically areas within close proximity to the access points, such as entrances of the restricted areas and/or areas in front of doors, in examples. Frictionless systems accomplish these tasks without requiring the individuals to swipe or wave keycards, for example, at card readers, and can more continuously track those users in and around buildings.

In these systems, users carry active wireless devices on their person that transmit credentials which identify the users to a wireless receiving device, or positioning unit. Credentials are also known as user information. The active wireless user devices, or user devices, include electronic devices such as key fobs (or fobs) or mobile computing devices such as smart phones or tablet computing devices. These user devices broadcast the user information, which can take the form of a token hash, or a token, among other examples. The user information is received by positioning units. The positioning units can then determine locations of the user devices (and thus the locations of the users) by using various positioning techniques of the antennas.

The positioning units send the user information and the location data to a verification and tracking system, which authenticates the users. Additionally, the verification and tracking system sends signals to door controllers to unlock the access points and to allow access to restricted areas associated with the access points when the positioning units determine that user devices (and thus the users) are in the immediate vicinity of/close proximity to the door or other access point.

### SUMMARY OF THE INVENTION

A limitation to frictionless access control systems is the reliance on wireless transmitters of mobile computing devices to broadcast user information to the positioning units. One problem is the unpredictable nature of the wireless transmission due to factors such as the way the mobile computing devices are manufactured or the location of the mobile computing device in relation to the positioning units. For example, some mobile computing devices use casings that impede wireless transmissions in certain directions and thus reduce the effective range of the mobile computing device's wireless transmitter depending on their orientation. Another problem concerns how the mobile computing devices are placed on the user's body. They can be located in such a way that the user's body attenuates transmission (for example, a phone located in the back pocket of the user). The transmission power of the wireless communication devices can be increased. However, increasing the transmission power decreases the battery life of the mobile computing devices.

The present system uses an ancillary user device that might be positioned between the mobile computing device and the positioning unit. This device receives the user information from the mobile computing device and transmits it to the positioning unit possibly as a repeater or after modifying the information. Before transmitting the user information, the ancillary user device is paired with the mobile computing device, and the user information is only broadcast if it is successfully verified that the user information originates from the paired mobile computing device. In this way, the ancillary user device acts as an intermediary between the mobile computing device and the positioning unit, strengthening the connection between the mobile computing device and the positioning unit, eliminating the need to possibly reposition the mobile computing device and preserving battery life on the mobile computing device.

In order to facilitate frictionless access control, the ancillary user device can be attached to the user via an attachment mechanism (for example, a lanyard or pin).

In one embodiment, the ancillary user device continuously rebroadcasts the user information immediately when it is received from the paired mobile computing device. In this case, the mobile computing device is required to be in range of the ancillary user device in order for the ancillary user device to transmit the user information to the positioning unit (for example, the user carries the mobile computing device in their back pocket and the ancillary user device attached to a lanyard around their neck).

In another embodiment, the user information is stored on the ancillary user device for a pre-determined period of time and is transmitted to the positioning unit regardless of whether the mobile computing device is within range of the ancillary user device at the moment of transmission. In one example, the user pairs the mobile computing device with the ancillary user device and then leaves the mobile computing device at their desk, taking only the ancillary user device. After a predetermined period of time, the ancillary user device requests updated user information from the mobile computing device.

In some cases, the ancillary user device transmits user information with an origin flag set, indicating that the user information received by the positioning unit originated from the ancillary user device and not the mobile computing device.

The user information that is transmitted from the mobile computing device to the ancillary user device might include a hash of a token.

In general, according to one aspect, the invention features an ancillary user device for interacting with access control systems, including a wireless interface and a controller. The wireless interface transmits user information to the access control systems, and the controller stores the user information received from a mobile computing device.

In embodiments, the wireless interface is a Bluetooth transceiver. The ancillary user device is paired with the mobile computing device, and user information is verified to have originated from the previously paired mobile computing device. The received user information can be stored before being transmitted and updated when it becomes stale. Further, the user information can be a token hash or a token. In the latter embodiment, the token is hashed by the ancillary user device before it is transmitted. An origin flag can be set on the user information by the ancillary user device before the user information is transmitted. The ancillary user device can be worn by a user via an attachment mechanism.

In general, according to another aspect, the invention features a method for providing user information to access control systems. A mobile computing device passes user information of a user to an ancillary user device, and the ancillary user device transmits the user information to the access control systems.

The above and other features of the invention including various novel details of construction and combinations of parts, and other advantages, will now be more particularly described with reference to the accompanying drawings and pointed out in the claims. It will be understood that the particular method and device embodying the invention are shown by way of illustration and not as a limitation of the invention. The principles and features of this invention may be employed in various and numerous embodiments without departing from the scope of the invention.

### BRIEF DESCRIPTION OF THE DRAWINGS

In the accompanying drawings, reference characters refer to the same parts throughout the different views. The drawings are not necessarily to scale; emphasis has instead been placed upon illustrating the principles of the invention. Of the drawings:

FIG. 1 is a schematic diagram of an exemplary access control system;

FIG. 2 is a block diagram of the ancillary user device;

FIG. 3 is a block diagram showing the processes executing on the one or more processors of the mobile computing device;

FIG. 4A is a block diagram showing the processes executing on the one or more processors of the mobile computing device of an embodiment of the ancillary user device in which the user information received from the mobile computing device is a token hash;

FIG. 4B is a block diagram showing the processes executing on the one or more processors of the mobile computing device of an embodiment of the ancillary user device in which the user information received from the mobile computing device is a token, and the user information is hashed by the ancillary user device;

FIG. 5 is a sequence diagram showing the method by which the user information is received by the ancillary user device and rebroadcast;

FIG. 6 is a sequence diagram showing an alternative embodiment in which the user information is received by the ancillary user device and stored before being rebroadcast;

FIG. 7 is a sequence diagram showing an alternative embodiment in which the user information is received by the ancillary user device, and an origin flag is set before the user information is rebroadcast;

FIG. 8 is a sequence diagram showing an alternative embodiment in which the user information is broadcast by the mobile computing device as a token, hashed by the ancillary user device, and then broadcast by the ancillary user device as a token hash.

### DETAILED DESCRIPTION OF THE PREFERRED EMBODIMENTS

The invention now will be described more fully hereinafter with reference to the accompanying drawings, in which illustrative embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art.

As used herein, the term “and/or” includes any and all combinations of one or more of the associated listed items. Further, the singular forms and the articles “a”, “an” and “the” are intended to include the plural forms as well, unless expressly stated otherwise. It will be further understood that the terms: includes, comprises, including and/or comprising, when used in this specification, specify the presence of stated features, integers, steps, operations, elements, and/or components, but do not preclude the presence or addition of one or more other features, integers, steps, operations, elements, components, and/or groups thereof. Further, it will be understood that when an element, including component or subsystem, is referred to and/or shown as being connected or coupled to another element, it can be directly connected or coupled to the other element or intervening elements may be present.

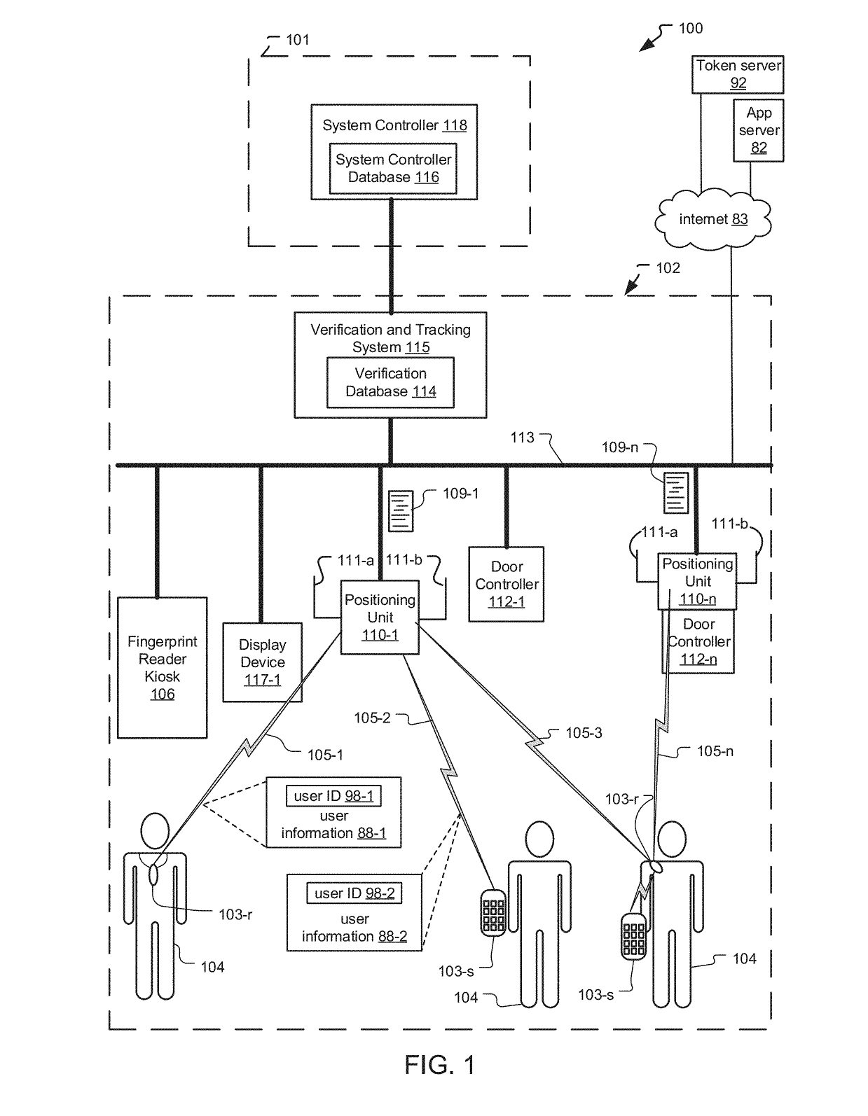

FIG. 1 is a schematic diagram of an exemplary access control system 100 to which the current invention is directed. The access control system 100 identifies users 104, tracks locations of user devices 103 such as smart phones 103-s or ancillary mobile computing devices 103-r, and enables access to restricted areas of a premises such as a building 102.

The system 100 also includes a verification and tracking system 115, and positioning units 110, and may further include additional components such as a fingerprint reader kiosk 106, display devices 117, and door controllers 112. These components communicate with one another over a data network 113. The positioning units 110 are often located near access points of the building 102 or areas within the buildings such as door access points that enable users 104 to physically enter or exit the building 102 or access different parts.

In a typical implementation, users 104 carry user devices 103, which broadcast packet data 105. The packet data 105 includes user information 88 for identifying the users. The user information 88 can include a unique user ID 98 for each of the user devices 103 and other information for identifying the user such as a username/password 99, name of user, department, work extension, personal phone numbers, email addresses, and employee ID number, in examples. In one example, the user information 88 includes a token or a hash of the token generated for the user 104, and it may or may not expire after a predetermined time.

Users carrying the user devices 103 enroll and/or register the user devices 103 with the system controller 118. When the user device is a smart phone or other mobile computing device, 103-s, the users 104 download a security app from the app server 82 to their user device 103-s, where the security app provides access to the system controller 118.

When enrolling a smart phone user device 103-s with a token as the user ID 98, the smart phone user devices 103-s and the system controller 118 might first access a token server 92 to request the token. In response, the token server 92 generates a token, and sends the token to both the system controller 118 and the user device 103 in response. The token is then included as the user ID 98 within the user information 88 for the user, for both the user information 88 maintained for the user in the system controller 118 and the user information 88 included within the user device 103.

The wireless packet data 105 broadcast from the user devices 103 is preferably secured to prevent unauthorized third parties from intercepting and viewing the packet data 105 during transmission (i.e. during broadcasts). In one example, the packet data 105 is encrypted. In a preferred embodiment, the user devices 103 broadcast the packet data 105 using BLE (Bluetooth low energy) technology.

Bluetooth is a wireless technology that operates in a 2.4 GHz (gigahertz) short-range radio frequency band. In free space, Bluetooth applications typically locate a Bluetooth device by calculating the distance of the user devices 103 from the signal receivers. The distance of the device from the receiver is closely related to the strength of the signal received from the device. A lower power version of standard Bluetooth called Bluetooth Low Energy (BLE), in contrast, consumes between ½ and 1/100 the power of classic Bluetooth. BLE is optimized for devices requiring maximum battery life, as compared to the emphasis upon higher data transfer rates associated with classic Bluetooth. BLE has a typical broadcast range of about 100-150 feet (approximately 35-46 meters).

When transmitting via BLE, the user devices 103 might send an AltBeacon compliant BLE broadcast message every second. If the user devices 103 utilize tokens as the user ID 98, the user devices 103 preferably include a hash representation of the token/user ID 98 in the BLE broadcast messages. In one implementation, the hash representation of the token is a 16-byte, one-way hash of the token, computed using the phone number of the user device 103-s as the seed key and possibly the current time.

In an alternative implementation, the user devices 103 are capable of broadcasting via standard Bluetooth. In still other alternative implementations, the user devices 103 may broadcast via other wireless technologies such as Wi-Fi (IEEE 802.11), active RFID (radio frequency identification), or ZigBee, to list a few examples.

The positioning units 110 each preferably include two or more antennas 111. The packet data 105 are received by antennas 111-a, 111-b of one or more positioning units 110-1 to 110-n, which are located throughout the building 102. The positioning units 110-1 to 110-n determine locations of the users 104 using one or more positioning techniques.

A preferred positioning technique compares the relative signal strengths of the received wireless signals between two antennas 111 of the positioning unit 110. Another positioning technique includes determining time of flight or time of receipt of packet data 105 received at each of the antennas 111 of a positioning unit 110. In yet another positioning technique example, the positioning units 110 employ triangulation between two or more positioning units 110 installed within the building. The positioning units 110 then convert the locations of the users 104 into location data 109 for each of the users. This will typically require the positioning units to share a common reference clock.

The positioning units 110-1 to 110-n receive the user information 88 for each user, and then send the user information 88 and the location data 109 to the verification and tracking system 115 via a data network 113. When the user devices 103 utilize tokens as the user ID 98, the positioning units 110 might extract the tokens from the hash representations of the tokens included in the packet data 105. The positioning units 110 use the phone number of the user devices 103 or other reference as the seed key for this purpose. The location data 109 are used by the verification and tracking system 115 to determine motion vectors for and to predict motion intent of the users 104, in examples.

Typically, the data network 113 is an enterprise network such as a Local Area Network (LAN), e.g., wired and/or wireless Ethernet. The positioning units 110-1 to 110-n can also communicate with the verification and tracking system 115 via serial connections, in another example.

The verification and tracking system 115 accesses authorization information 46 in a verification database 114, which it maintains or which it simply accesses, to determine which users 104 are authorized to access specified restricted areas of a building 102 and/or pass through an access point. Once the users 104 are authenticated by the verification and tracking system 115, the verification and tracking system 115 sends a door control signal via the network 113 to the door controller 112-1, in one example. The door controller 112-1 then enables access to a restricted area by unlocking an access point of the restricted area, such as a door 129 or other portal, thereby providing access for the authorized user 104 to the restricted area while also possibly generating an alarm for an unauthorized user. The door controller 112-1 preferably unlocks the door 129 when the authorized user 104 is within a threshold area 131 near the access point (e.g., the door or other portal) of the restricted area.

In a typical implementation, the system 100 includes the system controller 118, which includes a system controller database 116. In general, the system controller 118 might store various user information 88 for each of the users 104 to the system controller database 116. The system controller database 116 also stores the authorization information 46 for the users 104 (e.g., which users 104 are permitted to access which restricted areas). Periodically, the system controller 118 sends updated user information 88 and authorization information 46 to the verification and tracking system 115 via the network 113. In response, the verification and tracking system 115 saves the received user information 88 and authorization information 46 to its verification database 114.

The verification and tracking system 115 accesses the user information 88 and authorization information 46 within its verification database 114, which acts as a local copy or “cache” of the information. To manage the temporal relevance of the entries in its verification database 114, the verification and tracking system 115 maintains a current time, and applies a time stamp to each item of user information 88 and authorization information 46 received from the system controller 118.

Typical embodiments of the system 100 include display devices 117-1 to 117-n. These display devices 117-1 to 117-n could be screens of access control readers or standalone display devices (e.g., LCD screen), for example. In one embodiment, the display devices 117-1 to 117-n are wirelessly connected to the network 113. In an alternative embodiment, the display devices 117-1 to 117-n are connected via wired connections and receive power via PoE (power over Ethernet). The display devices 117-1 to 117-n, if used, display messages to the users 104 such as “access granted”, “access denied”, warnings about low power conditions of the user devices 103 or warnings about emergency situations, in examples.

A fingerprint reader kiosk 106 may also be deployed in some embodiments of the system 100 In some high-security situations, users are required to periodically return to the fingerprint reader kiosk 106 and scan their fingerprint(s) to re-authenticate with the system 100. This process helps ensure that the user in possession of the fob or other user device 103 is also the registered owner of the user device 103.

According to the current invention, an ancillary user device 103-r is used in conjunction with the mobile computing device 103-s in order to broadcast packet data 105 containing user information 88 to the positioning unit 110. In general, the ancillary user device 103-r is first paired with the mobile computing device 103-s and then receives user information 88 broadcast from any mobile computing device 103-s. The ancillary user device 103-r verifies that the received user information 88 originated from the previously paired mobile computing device 103-s. If so, the ancillary user device 103-r broadcasts the user information 88. Preferably, the ancillary user device 103-r is positioned between the positioning unit 110 and the mobile computing device 103-s such that the positioning unit 110 successfully receives the broadcast user information 88 even when the mobile computing device 103-s is out of broadcast range or otherwise blocked (for example, by the body of the user 104 if the mobile computing device 103-s is in the user's back pocket).

In one embodiment, the ancillary user device 103-r continuously rebroadcasts the user information 88 immediately when it is received from the paired mobile computing device 103-s. In this case, the mobile computing device 103-s is required to be in range of the ancillary user device 103-r in order for the ancillary user device to transmit the user information 88 to the positioning unit 110 (for example, the user carries the mobile computing device 103-s in their back pocket and the ancillary user device attached to a lanyard around their neck).

In another embodiment, the user information 88 is stored on the ancillary user device for a pre-determined period of time and is transmitted to the positioning unit 110 regardless of whether the mobile computing device 103-s is within range of the ancillary user device 103-r at the moment of transmission. In one example, the user pairs the mobile computing device 103-s with the ancillary user device 103-r and then leaves the mobile computing device 103-s at their desk, taking only the ancillary user device 103-r. After a predetermined period of time, the ancillary user device 103-r requests updated user information 88 from the mobile computing device 103-s.

In another embodiment, the ancillary user device 103-r transmits user information 88 with an origin flag set, indicating that the user information received by the positioning unit 110 originated from the ancillary user device 103-r and not the mobile computing device 103-s.

In some embodiments, the user information 88 that is transmitted from the mobile computing device 103-s to the ancillary user device 103-s is a hash token. In other embodiments, the user information 88 transmitted from the mobile computing device 103-s to the ancillary user device 103-r is a token, which is hashed by the ancillary user device 103-r before being transmitted to the positioning unit 110.

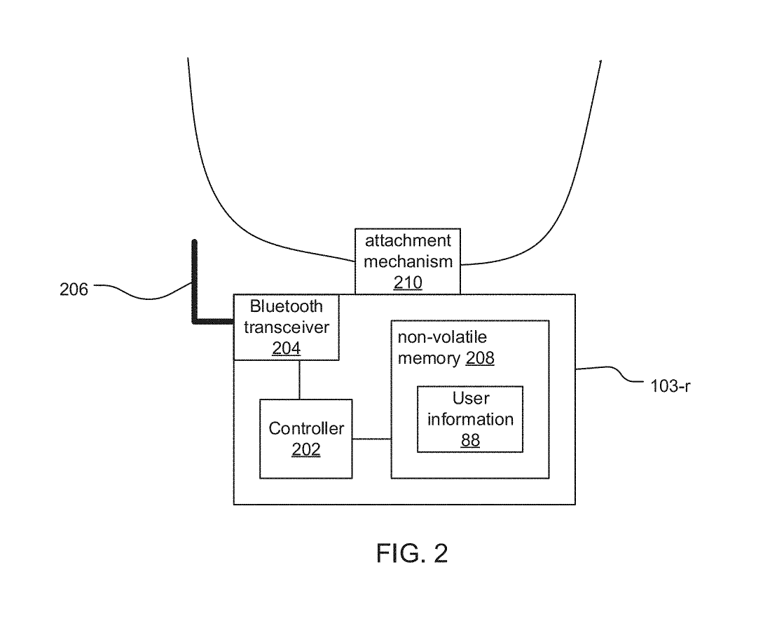

FIG. 2 is a block diagram of the ancillary user device 103-r. The device includes a controller 202, a Bluetooth transceiver 204, a Bluetooth antenna 206, non-volatile memory 208, and an attachment mechanism 210.

The controller 202 executes firmware instructions stored on the non-volatile memory and drives Bluetooth transceiver 204, which sends and receives packet data 105 via the Bluetooth antenna 206. The non-volatile memory also stores user information 88 received from a paired mobile computing device 103-s. The ancillary user device 103-r can be attached to the user 104 via the attachment mechanism 210, which can be a pin or lanyard, among other examples.

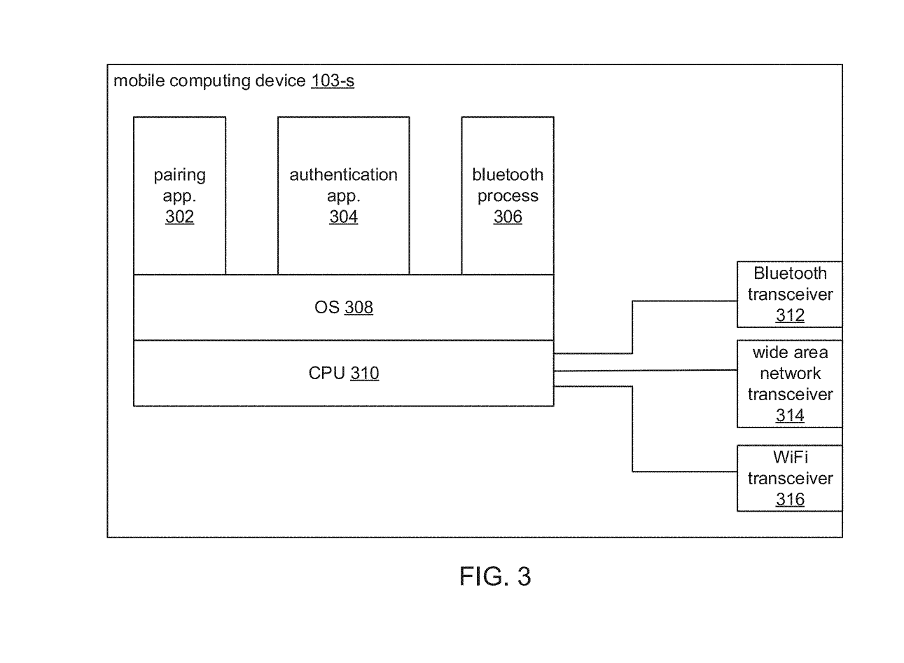

FIG. 3 is a software block diagram of the mobile computing device 103-s. The mobile computing device includes a pairing application 302, an authentication application 304, a Bluetooth process 306, an operating system (OS) 308, a CPU 310, a Bluetooth transceiver 312, a wide area network transceiver 314 and a WiFi transceiver 316. The CPU 310 sends and receives data to and from the transceivers 312, 314, 316 and drives the OS 308, which in turn directs the basic functionality of the device, including the pairing application 302, the authentication application 304 and the Bluetooth process 306. The Bluetooth transceiver 312 sends and receives data to and from devices such as the ancillary user device 103-r and the positioning unit 110. The wide area network transceiver 314 sends and receives data over a wide area network, such as the internee 83 (for example, via cellular data). The Win transceiver 316 sends and receives data wirelessly over a local area network.

The Bluetooth process 306 directs the functionality of the Bluetooth transceiver.

The pairing application 302 pairs the mobile computing device 103-s with the ancillary user device 103-r by sending and receiving device identification data to and from the ancillary user device 103-r via the Bluetooth transceiver 312.

The authentication application 304 generates and stores the user information 88 and broadcasts the user information 88 via the Bluetooth transceiver 312.

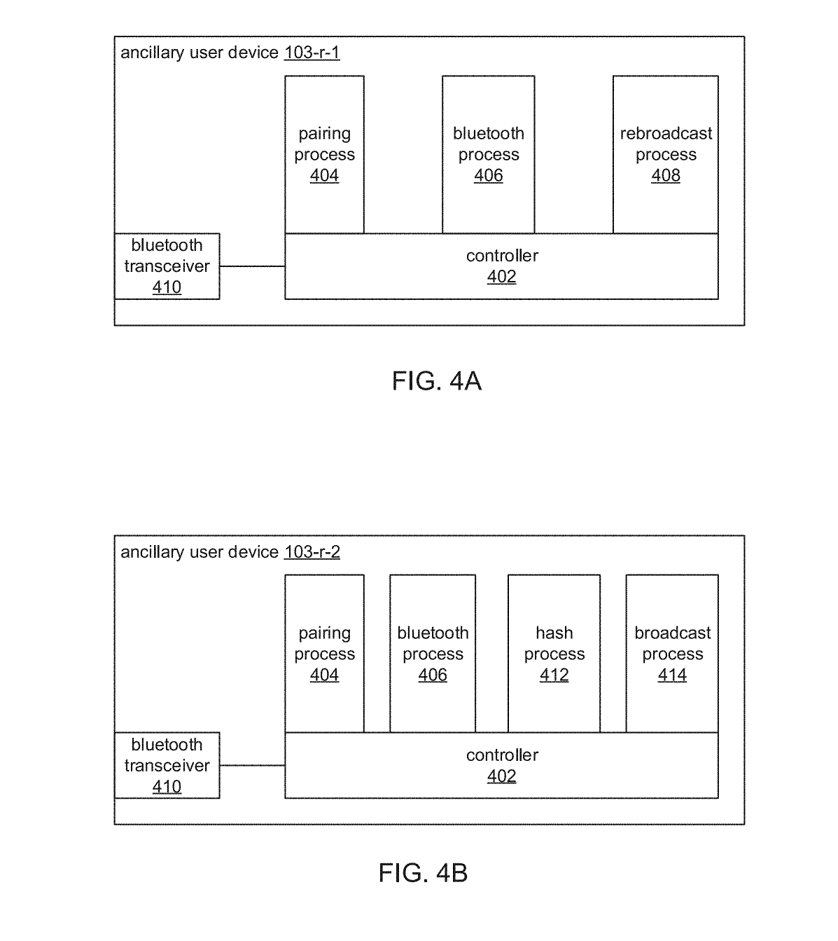

FIGS. 4A and 4B are software block diagrams of two embodiments of the ancillary user device 103-r. In general, the ancillary user device 103-r includes a controller 402, a Bluetooth transceiver 410, a pairing process 404, and a Bluetooth process 406. The controller 402 sends and receives data to and from the Bluetooth transceiver 410 and directs the basic functionality of the device, including the various processes. The Bluetooth process 406 directs the functionality of the Bluetooth transceiver 410, which sends and receives data to and from devices such as the mobile computing device 103-s and the positioning unit 110. The pairing process 404 pairs the ancillary user device 103-r with the mobile computing device 103-s by sending and receiving device identification data to and from the mobile computing device 103-s via the Bluetooth transceiver 410.

FIG. 4A is a software block diagram of a particular embodiment of the ancillary user device 103-r in which the user information 88 received from the mobile computing device 103-s is a token hash. In this embodiment, a rebroadcast process 408 receives user information 88 from any mobile computing device 103-s, verifies that the user information 88 originated from the previously paired mobile computing device 103-s, and then rebroadcasts the user information 88 via the Bluetooth transceiver 410.

FIG. 4B is a software block diagram of an alternative embodiment of the ancillary user device 103-r in which the user information 88 received from the mobile computing device 103-s is a token. This embodiment includes a hash process 412 and a broadcast process 414. The broadcast process 414 verifies that the user information 88 originated from the previously paired mobile computing device 103-s. If so, it sends the user information 88 to the hash process 412, which generates a token hash. The broadcast process 414 then broadcasts the token hash generated by the hash process 412 via the Bluetooth transceiver 410.

Additionally, in alternative embodiments, both the rebroadcast process 408 and the broadcast process 414 set an origin flag on the user information 88 indicating that the user information 88 being broadcast originates from the ancillary user device 104-r and not the mobile computing device 103-s.

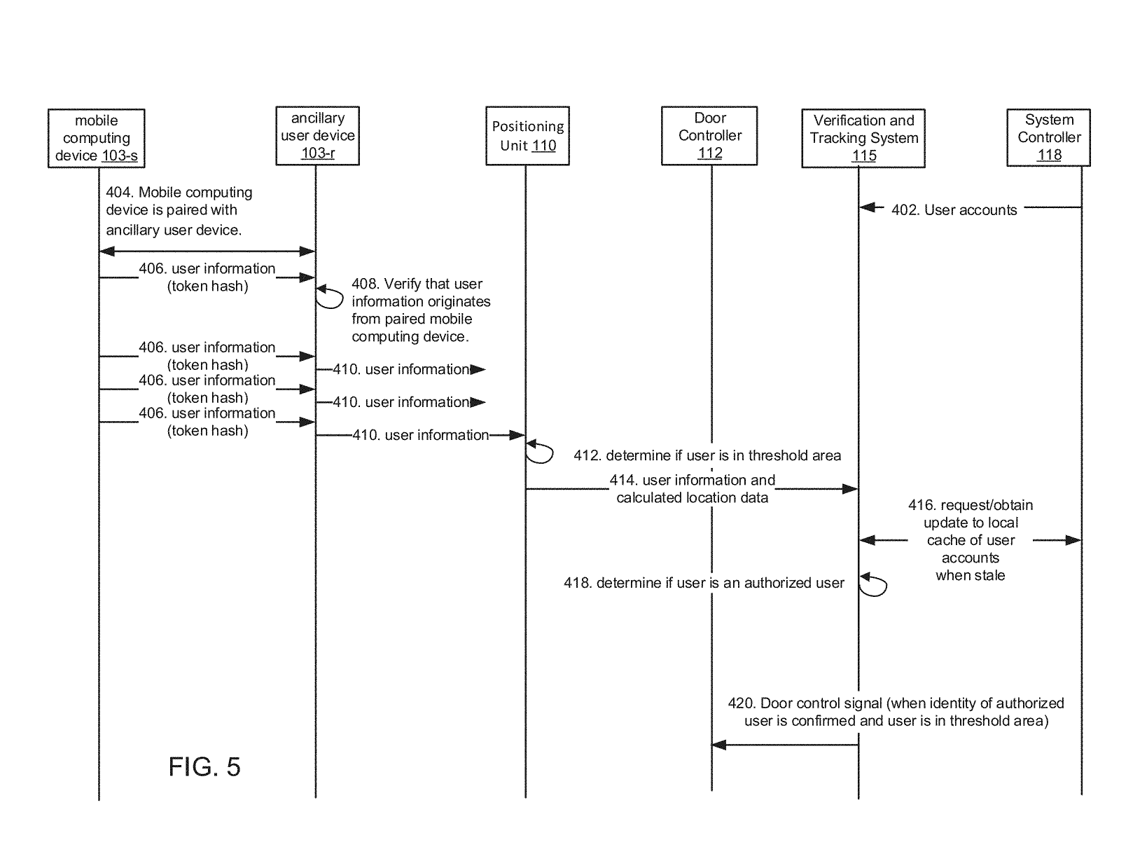

FIG. 5 is a sequence diagram showing the method by which the user information 88 is received by the ancillary user device 103-r and rebroadcast.

First, in step 402, user accounts including user information 88 and authorization information are sent from the system controller 118 to the verification and tracking system 115 via the network 113. This updates a local “cache” of user accounts 19 including user information 88 and authorization information 46 within the verification database 114 of the verification and tracking system 115. The system controller 118 periodically updates the cache of user accounts 19 on the verification and tracking system 115 at regular intervals daily, weekly).

In step 404, the mobile computing device 103-s is paired with the ancillary user device 103-r.

In step 406, the user information 88 is continuously broadcast as a token hash by the mobile computing device 103-s and received by the ancillary user device 103-r. In step 408, the ancillary user device 103-r verifies that the user information 88 originates from the previously paired mobile computing device 103-s. If the user information 88 is determined to have originated from the previously paired mobile computing device 103-s, in step 410, the user information 88 is rebroadcast.

It should be noted that the mobile computing device 103-s often broadcasts user information 88 on a continuous basis, regardless of whether the ancillary user device 103-r detects or verifies the user information 88. Similarly, the ancillary user device 103-r rebroadcasts the user information 88 on a continuous basis, regardless of whether the positioning unit 110 detects the user information 88. Additionally, it should be noted that the verification in step 408 is performed by the ancillary user device 103-r for every iteration of user information 88 received from the mobile computing device 106-s. However, for the purpose of clarity, step 408 is only illustrated once.

When the positioning unit 110 detects the user information 88 broadcast by the ancillary user device 103-r, it calculates the location of the user device 103, and determines if the user device (and therefore if the user) is in a predetermined threshold area in step 412. The user information 88 and the location data 109 are then sent to the verification and tracking system 115 for authentication in step 414.

According to step 416, the verification and tracking system 115 can request an update to its local cache of user accounts when stale. The information within the user accounts is stale if its time stamp indicates that it is older than a predetermined threshold value (e.g. one hour) as compared to the current time, in one example.

In step 418, the verification and tracking system 115 then determines if the user 104 is an authorized user for the access point. For this purpose, the verification and tracking system 115 first compares the user information 88 forwarded from the positioning unit 110 to the stored user information 88 within its local cache of user accounts. If required, the verification and tracking system 115 may confirm user status and account information with the system controller 118 if the users' information 88 has not been previously sent to the verification and tracking system 115. Upon finding a match, the verification and tracking system 115 then executes a lookup of the matched user information 88 against the locally stored authorization information in the cache for the user. If the authorization information indicates that the user is allowed access to the access point near the positioning unit 110, the verification and tracking system 115 identifies the user 104 as an authorized user for the access point. In one implementation, this occurs when the matched user information 88 is referenced within the authorization information.

In step 420, if the user is an authorized user, and the user's user device 103 was also determined to be within the threshold area, then the verification and tracking system 115 sends a door control signal to the door controller 112 to enable access to the access point of the restricted area (e.g., unlock the door).

In one example, the user 104 carries the mobile computing device 103-s in their back pocket and the ancillary user device 103-r attached to a lanyard around their neck. The mobile computing device 103-s continuously broadcasts the user information 88 to the ancillary user device 103-r, and the ancillary user device 103-r continuously verifies the user information 88 and rebroadcasts it. As the user 104 approaches a locked door, the positioning unit 110 receives the user information 88 from the ancillary user device 103-r, the user information 88 is authenticated by the access control system 100, and the door unlocks.

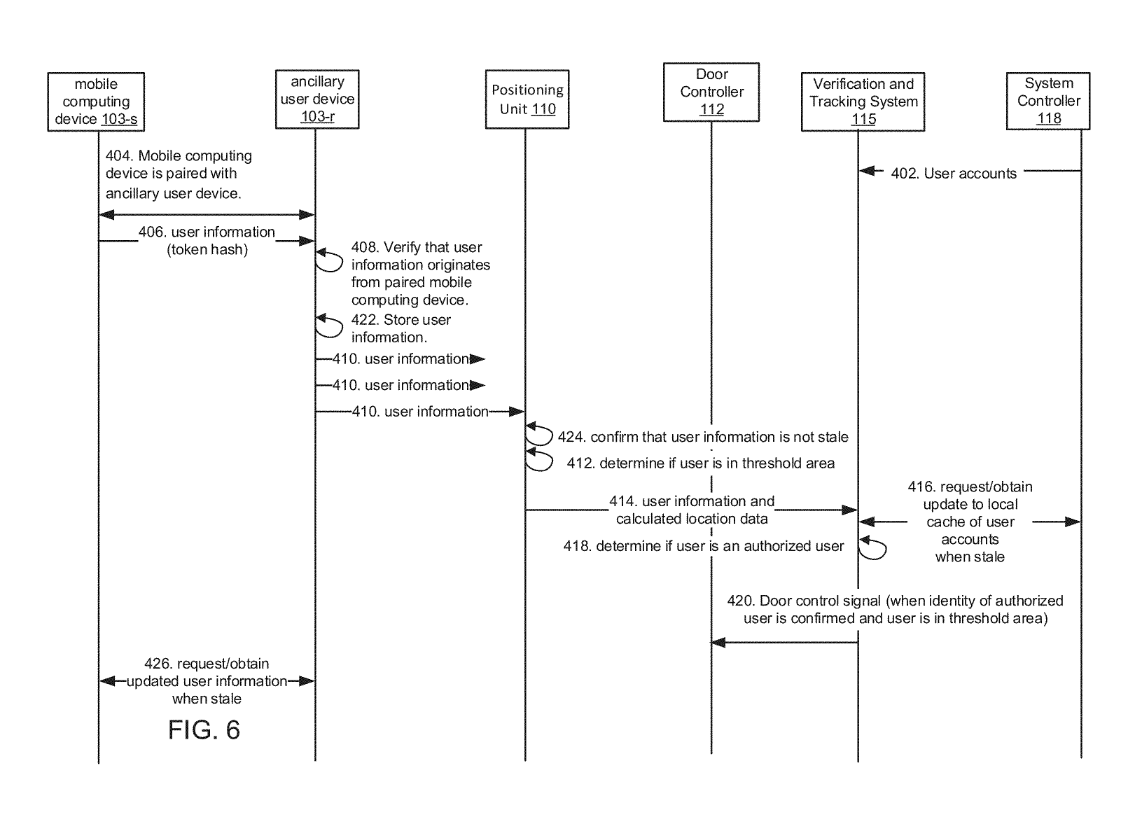

FIG. 6 is a sequence diagram showing an alternative embodiment in which the user information 88 is received by the ancillary user device 103-r and stored before being rebroadcast.

Steps 404 through 408 proceed as previously described. However, in step 422, after the user information 88 is received and verified by the ancillary user device 103-r, it is stored in nonvolatile memory by the ancillary user device 103-r. In this embodiment, the stored user information 88 is broadcast in step 410. After receiving the user information 88 from the mobile computing device 103-s, the ancillary user device 103-r can broadcast the user information 88 independently, without continuously receiving further iterations of the user information 88 from the mobile computing device 103-s.

Steps 410 through 420 proceed as previously described. In step 426, updated user information 88 is requested and obtained by the ancillary user device 103-r from the mobile computing device 103-s after a predetermined period of time.

In one example, the user 104 pairs the mobile computing device 103-s with the ancillary user device 103-r and then leaves the mobile computing device 103-s at their desk, taking only the ancillary user device 103-r to the access point. The ancillary user device 103-r independently broadcasts the stored user information 88 to the positioning unit 110. After a few hours, the user information 88 stored on the ancillary user device 103-r is no longer valid, and updated user information 88 is requested and obtained when the user 104 returns to their desk and the ancillary user device 103-r is within range of the mobile computing device 103-s.

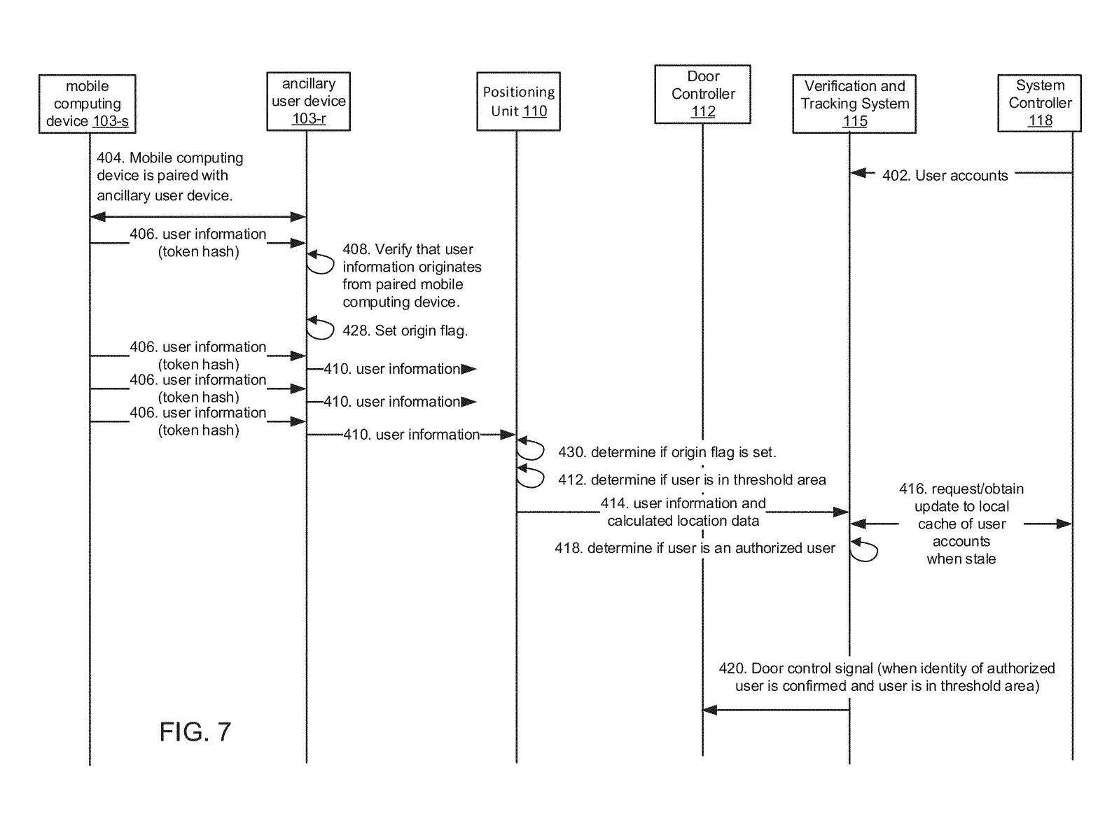

FIG. 7 is a sequence diagram showing an alternative embodiment in which the user information 88 is received by the ancillary user device 103-r, and an origin flag is set before the user information 88 is rebroadcast.

Steps 404 through 408 proceed as previously described. However, in step 428, an origin flag is set, indicating that the user information 88 that is broadcast by the ancillary user device 103-r originated from the ancillary user device 103-r and not the mobile computing device 103-s. In step 430, once the user information 88 is received by the positioning unit 110, it is determined whether the origin flag is set. Steps 412 through 420 then proceed as previously described.

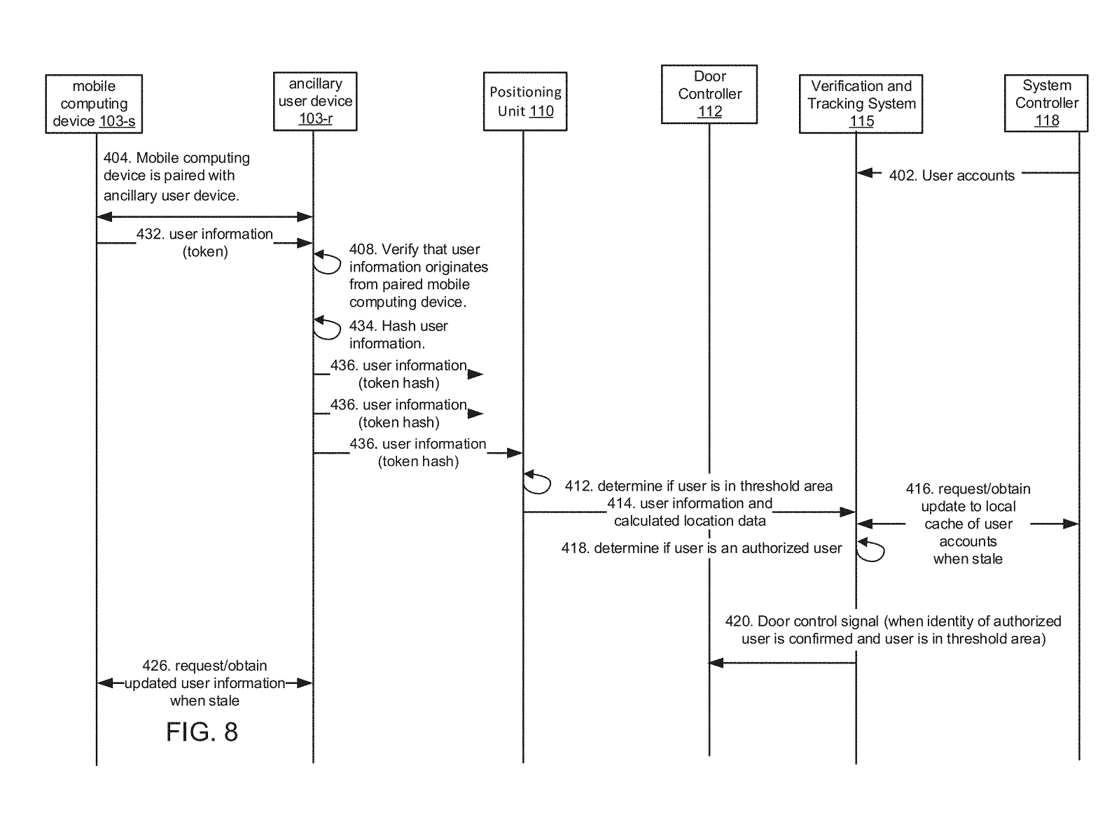

FIG. 8 is a sequence diagram showing an alternative embodiment in which the user information 88 is broadcast by the mobile computing device 103-s as a token, hashed by the ancillary user device 103-r, and then broadcast by the ancillary user device 103-r as a token hash.

Steps 402 through 404 proceed as previously described. However, in step 432, the user information 88 is broadcast by the mobile computing device 103-s in the form of a token instead of a token hash. After the user information 88 is received and verified by the ancillary user device 103-r, in step 434, the user information 88 is hashed. In step 436, the user information 88 is broadcast by the ancillary user device 103-r as a token hash. Steps 412 through 420 proceed as previously described. Finally, in step 426, updated user information 88 is requested and obtained by the ancillary user device 103-r from the mobile computing device 103-s.

While this invention has been particularly shown and described with references to preferred embodiments thereof, it will be understood by those skilled in the art that various changes in form and details may be made therein without departing from the scope of the invention encompassed by the appended claims.

1. An ancillary user device for interacting with access control systems, the device comprising:
a wireless interface for transmitting user information to the access control systems; and
a controller for storing the user information, which was received from a mobile computing device.

2. The device according to claim 1_{;} wherein the wireless interface for transmitting user information to the access control systems is a Bluetooth transceiver.

3. The device according to claim I, wherein the ancillary user device is paired with the mobile computing device.

4. The device according to claim 3, wherein the ancillary user device verifies that the user information originates from the mobile computing device that was previously paired with the ancillary user device.

5. The device according to claim 1, wherein the user information is a token hash.

6. The device according to claim 1, wherein the user information is stored before being transmitted to the access control systems.

7. The device according to claim 6, wherein updated user information is received from the mobile computing device when the user information stored on the ancillary user device becomes stale.

8. The device according to claim 1, wherein an origin flag is set on the user information by the ancillary user device before the user information is transmitted to the access control systems.

9. The device according to claim 1, wherein the user information is a token.

10. The device according to claim 9, wherein the user information is hashed by the ancillary user device before it is transmitted to the access control systems.

11. The device according to claim 1, wherein the ancillary user device is worn by a user via an attachment mechanism.

12. A method for providing user information to access control systems, comprising:
a mobile computing device passing user information of a user to an ancillary user device; and
the ancillary user device transmitting the user information to the access control systems.

13. The method according to claim 12, wherein the user information is transmitted via a Bluetooth transceiver.

14. The method according to claim 12, wherein the ancillary user device is paired with the mobile computing device.

15. The method according to claim 14, wherein the ancillary user device verifies that the user information received from the mobile computing device originates from the mobile computing device that was previously paired with the ancillary user device.

16. The method according to claim 12, wherein the user information is a token hash.

17. The method according to claim 12, wherein the user information is stored before being transmitted to the access control systems.

18. The method according to claim 17, wherein updated user information is received from the mobile computing device when the user information stored on the ancillary user device becomes stale.

19. The method according to claim 12, wherein an origin flag is set on the user information by the ancillary user device before the user information is transmitted to the access control systems.

20. (canceled)

21. The method according to claim 12, wherein the user information is hashed by the ancillary user device before it is transmitted to the access control systems.

22. (canceled)

23. An ancillary user device for interacting with access control systems, the device comprising:
a wireless interface for transmitting user information including a token hash to the access control systems;
a controller for storing the user information including the token hash, which was received from a mobile computing device; wherein updated user information is received from the mobile computing device when a current token hash stored on the ancillary user device becomes stale; and
an attachment mechanism enabling the ancillary user device to be worn by a user.

24. A method for providing user information to an access control system and controlling an access point, comprising:
a mobile computing device passing user information of a user to an ancillary user device;
the ancillary user device receiving the user information and verifying that the user information originated from the mobile computing device to which the ancillary user device is paired;
the ancillary user device then transmitting the user information to the access control system;
a positioning unit located near an access point detecting the user information broadcast by the ancillary user device and determining whether a user is in a predetermined threshold area of the access point;
a verification system determining if the user is an authorized user for the access point based on the user information broadcast by the ancillary user device; and
if the user is determined to be an authorized user and the user was also determined to be within the threshold area, then a door controller is signaled to enable access through the access point.
